(19) United States
(12) Patent Application Publication
(10) Pub. No.: US 2022/0318139 A1
(43) Pub. Date: Oct. 6, 2022

(54) PROCESSOR SUPPORTING TRANSLATION LOOKASIDE BUFFER (TLB) MODIFICATION INSTRUCTION FOR UPDATING HARDWARE-MANAGED TLB AND RELATED METHODS

(71) Applicant: Microsoft Technology Licensing, LLC, Redmond, WA (US)

(72) Inventors: Thomas Philip SPEIER, Wake Forest, NC (US); William J. MCAVOY, Raleigh, NC (US); Robert Douglas CLANCY, Cary, NC (US); Bruce J. SHERWIN, JR., Woodinville, WA (US)

(21) Appl. No.: 17/217,743

(22) Filed: Mar. 30, 2021

(51) Int. Cl. G06F 12/0802; G06F 9/455

(52) U.S. Cl. CPC G06F 12/0802; G06F 9/45558; G06F 2009/45583; G06F 2212/68

(57) ABSTRACT

A processor supporting a translation lookaside buffer (TLB) modification instruction for updating a hardware-managed TLB is disclosed. A page table (PT) entry (PTE) corresponding to a virtual memory address is identified by a PT walking circuit walking the PT and a corresponding TLB entry is created. An execution circuit in the processor executes a TLB modification instruction to cause the TLB entry corresponding to the virtual memory address to be updated based on an update to the PT mapping information in the PTE corresponding to the virtual memory address. In one example, a portion of the PT mapping information in a PTE corresponding to a virtual memory address is stored in a TLB mapping information in a TLB entry corresponding to the virtual memory address in response to the TLB modification instruction being executed by the execution circuit without invalidating the TLB entry.

### FIELD OF THE DISCLOSURE

The technology of the disclosure relates to processor-based systems employing processors that include a memory management unit (MMU), and more specifically to the MMU managing a translation lookaside buffer (TLB) used to translate a virtual address (VA) to a physical address (PA) for fast memory accesses.

### BACKGROUND

Processors perform computational tasks for a wide variety of applications. A conventional processor includes one or more central processing units (CPUs) also known as processor cores. A processor in a processor-based system accesses a memory system to retrieve computer instructions for execution by the processor and also to retrieve data that is used in the execution of computer instructions. Data generated by execution of the computer instructions can be stored back into the memory system. The memory system includes a system memory located either on-chip with the processor core or off-chip and also includes a secondary memory. The system memory is configured to be accessed with a physical memory address. The memory system may also include a cache memory system that includes one or more levels of cache memory with faster access time(s) than the system memory. Cache memories are configured to store a subset of frequently accessed data for improved memory access performance.

Multiple processes may be executed on the processor in a time-sharing manner and those processes may access the same memory system. With multiple processes attempting to access the same physical memory addresses in a memory system, conflict between the processes is inevitable. Therefore, the process instructions access a memory location using a virtual memory address that is translated to a physical memory address by an operating system that oversees access to memory for all the processes. The data stored in cache memories may be accessed based on the physical memory address used in the system memory or based on the virtual memory address, depending on the processor core. To access data, a process issues a data access request using a process virtual memory address that is mapped to an actual physical memory address in the memory system. The actual physical memory address corresponds to a memory location at which the data may be stored. Each processor core may contain a memory management unit (MMU) to access the system memory. The MMU is configured to translate the process virtual memory addresses to physical memory addresses. An in-memory “page table” stores mapping information for translating the process virtual memory addresses to physical memory addresses. A page table is a data structure that contains a plurality of page table (PT) entries (PTEs) for translating virtual addresses to physical addresses for each memory page. Most page tables have multiple levels that depend upon the size of a memory page, the number of page table entries at each level of the page table, and the number of bits of virtual memory space supported. Finding translation information for a process virtual address requires “walking” through multiple levels of the page table.

In this regard, FIG. 1 illustrates an example of a multiple level page table 100 that includes three (3) levels of level page tables 102(0)-102(2) that is configured to be accessed to convert a virtual address (VA) 104 to a physical address (PA). The level page tables 102(0)-102(2) are organized to provide for a base page size of 4 Kilobytes (KB) where the number of PTEs at each level page table is 512 (i.e., addressable by 9 bits) with a 39-bit VA space supported. The top level (level 2) page table 102(2) is at level 2 and is indexed by a level 2 index in bits 38-30 of the VA 104. The page table entries (entry 0-entry 511) of the level 2 page table 102(2) point to one of an ‘X’ number of level 1 page tables 102(1)(0)-102(1)(X). The level 1 page tables 102(1)(0)-102(1)(X) are indexed by a level 1 index in bits 29-21 of the VA 104. The page table entries in the level 1 page table 102(1)(0) points to one of ‘Y’ number of level 0 page tables 102(0)(0)-102(0)(Y), which is then indexed by a level 0 index in bits 20-12 of the VA 104. In this example, page table entries accessed across the level page tables 102(0)-102(2) in the page table 100 identify a PA of a 4K page in physical memory. The offset bits of PA for the VA 104 is the offset in the VA 104 in bits 11-0 in this example.

In processor cores in which the translation lookaside buffer (TLB) is managed by the MMU, the MMU includes a page table walker circuit to find a PT entry (PTE) containing the VA to a PA translation. For a given VA, the page table walker circuit walks the page table from the top level, descending the level page tables until it finds the leaf PTE that contains the corresponding PA. Walking the page table can be time consuming because the page table walker circuit accesses memory at each level of the page table. To reduce the instances of walking the page table, MMUs typically include a high-speed cache memory called a TLB. The TLB caches the PTEs that are most likely to be used again soon by the processor, according to a PTE replacement algorithm. In one example, the TLB caches the most recent VA to PA translations. In response to a memory access request in which a VA to PA translation is required, the MMU first accesses the TLB based on the VA of the memory access request. If the TLB does not contain an entry corresponding to the VA, a TLB miss occurs and the MMU walks the page table until it finds the PTE containing the VA to PA translation. When the VA to PA translation is found, it may be stored in an entry in the TLB for future use. Finding that the VA to PA translation is present in the TLB is referred to as a TLB hit. When there is a TLB hit, walking the page table is not necessary. If the VA to PA translation is not found in the page table, a page fault occurs, which means the data is not in system memory and must be retrieved from secondary memory.

In some situations, an operating system (OS) running in a processor core programs the page tables to map the VA to PA translations for multiple processes. A processor core may run more than one OS. For example, a processor core may run multiple guest virtual machines (VMs), each having its own guest OS. The respective guest OSs each maintain a separate OS page table to translate a process VA of the VM to a guest PA based on the guest OS's view of system memory. A hypervisor running on the processor core can maintain a hypervisor PT that is used to translate the guest PAs of all the respective VMs to actual PAs (hypervisor PAs or host PAs). In this manner, the hypervisor avoids memory conflicts between the guest VMs. Every process VA generated in a processor core while executing a VM instruction is translated first to a guest PA and then to the host PA. High speed address translation is made possible by storing, in each TLB entry, a host PA that corresponds with each process VA. When there is a TLB miss, a page table walker circuit in the MMU can walk the guest page table to find the guest PA. The page table walker circuit then walks the hypervisor PT to find a PTE with the host PA corresponding to the guest PA. Memory is accessed at every level of the walk, causing a long delay for accessing the memory location. System performance can be increased by reducing the instances in which the MMU walks any page tables.

### SUMMARY

Exemplary aspects disclosed herein include a processor supporting a translation lookaside buffer (TLB) modification instruction for updating a hardware-managed TLB. Related methods of a processor updating TLB entries in the hardware-managed TLB based on execution of the TLB modification instruction are also disclosed. System management software in a processor-based system maps virtual memory addresses to physical memory addresses using page table (PT) mapping information in PT entries (PTEs) in a PT stored in system memory. A memory management unit (MMU) circuit locates the PT mapping information for a virtual memory address being accessed by a memory access instruction. Locating the PT mapping information includes an MMU PT walking circuit walking the PT to locate the PTE corresponding to the virtual memory address. The MMU circuit also creates a corresponding TLB entry in a TLB based on the PTE. Having a TLB entry in a TLB that is managed by the MMU circuit (e.g., hardware-managed TLB) reduces memory access time because a PT walk is unnecessary. Conventionally, system management software makes some changes to a PTE that will not be recognized by the MMU circuit. In these cases, the TLB entries are invalidated to force the MMU circuit to re-walk the PT to recreate the TLB entry. In exemplary aspects disclosed herein, an execution circuit in the processor is configured to execute a TLB modification instruction to cause the TLB entry in the TLB corresponding to a virtual memory address to be updated based on the PT mapping information in the PTE corresponding to the virtual memory address. In this manner, memory access time can be reduced because performing this update in the TLB without invalidating the TLB entry can avoid the need for the MMU PT walking circuit to walk the PT again.

In an example, an updated portion of the PT mapping information in a PTE corresponding to a virtual memory address may be stored in a TLB mapping information in a TLB entry corresponding to the virtual memory address in response to the TLB modification instruction being executed by the execution circuit. As an example, system management software, such as an operating system or hypervisor, resets a dirty bit in the FTE when data in the system memory has been written back to a secondary memory. However, the MMU circuit may not detect the dirty bit in the PTE being reset. The system management software in the conventional processor-based system invalidates the TLB entry to force the MMU circuit to walk the PT and recreate the TLB entry. The exemplary processor-based system disclosed herein supports a TLB modification instruction that can cause the dirty bit, for example, to be reset in the TLB entry. Thus, the TLB entry does not need to be invalidated and the MMU PT walking circuit does not need to walk the PT.

In an exemplary aspect, a processor-based system including an execution circuit and an MMU circuit is disclosed. The execution circuit is configured to generate a memory request to access a system memory based on a first virtual memory address. The MMU circuit comprises a TLB circuit comprising a plurality of TLB entries each corresponding to a virtual memory address. The MMU circuit is configured to update a TLB mapping information in a TLB entry of the plurality of TLB entries corresponding to the first virtual memory address based on a PT mapping information in a PTE in a PT in the system memory. The execution circuit is further configured to execute a first instruction to cause an update to the PT mapping information in the PTE corresponding to the first virtual memory address. The execution circuit is also configured to execute a TLB modification instruction to cause the TLB mapping information in the TLB entry corresponding to the first virtual memory address to be updated based on the PT mapping information.

In another exemplary aspect, a method in a processor-based system is disclosed. The method comprises generating, in an execution circuit, a memory request to access a system memory based on a first virtual memory address and updating, by an MMU circuit, a TLB mapping information in a TLB entry in a TLB circuit comprising a plurality of TLB entries. The updating the TLB mapping information further comprises updating the TLB mapping information in response to the memory request based on a PT mapping information in a PTE corresponding to the first virtual memory address in a PT in the system memory. The method further comprises executing, in the execution circuit, a first instruction to cause an update to the PT mapping information in the PTE corresponding to the first virtual memory address and a TLB modification instruction to cause the TLB mapping information in the TLB entry corresponding to the first virtual memory address to be updated based on the PT mapping information.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is an example of a multiple level page table included in a memory management unit (MMU) of a processor for translating a virtual address (VA) to a physical address (PA) in memory;

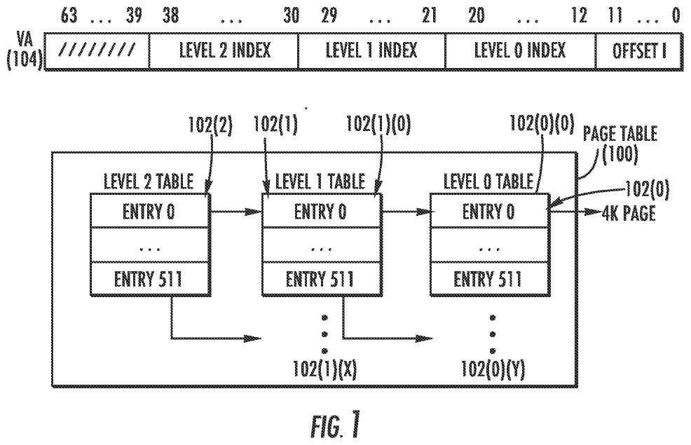

FIG. 2 is a block diagram of an exemplary processor-based system including a processing element with an MMU circuit managed TLB and an execution circuit that can execute a TLB modification instruction to cause a TLB entry to be updated based on an update to a page table (PT) entry;

FIG. 3 is a diagram illustrating an example of data fields in a page table entry and a TLB entry in the processor-based system of FIG. 2;

FIG. 4 is a flow chart of an exemplary method in the processor-based system of FIG. 2 of executing a TLB modification instruction to update a TLB based on an update to the page table;

FIG. 5 is a block diagram of another exemplary processor-based system including a processing element with an MMU circuit managed TLB and an execution circuit that can execute a TLB modification instruction to cause a TLB entry to be updated based on an update to a PT entry (PTE); and

FIG. 6 is a block diagram of an exemplary processor-based system including a plurality of devices coupled to a system bus, wherein an operating system controls a processor to execute a TLB modification instruction, as in the processor-based system shown in FIGS. 2 and 5.

### DETAILED DESCRIPTION

Exemplary aspects disclosed herein include a processor supporting a translation lookaside buffer (TLB) modification instruction for updating a hardware-managed TLB. Related methods of a processor updating TLB entries in the hardware-managed TLB based on execution of the TLB modification instruction are also disclosed. System management software in a processor-based system maps virtual memory addresses to physical memory addresses using page table (PT) mapping information in PT entries (PTEs) in a PT stored in system memory. A memory management unit (MMU) circuit locates the PT mapping information for a virtual memory address being accessed by a memory access instruction. Locating the PT mapping information includes an MMU PT walking circuit walking the PT to locate the PTE corresponding to the virtual memory address. The MMU circuit also creates a corresponding TLB entry in a TLB based on the PTE. Having a TLB entry in a TLB that is managed by the MMU circuit (e.g., hardware-managed TLB) reduces memory access time because a PT walk is unnecessary. Conventionally, system management software makes some changes to a PTE that will not be recognized by the MMU circuit. In these cases, the TLB entries are invalidated to force the MMU to re-walk the PT to recreate the TLB entry. In exemplary aspects disclosed herein, an execution circuit in the processor is configured to execute a TLB modification instruction to cause the TLB entry in the TLB corresponding to a virtual memory address to be updated based on the PT mapping information in the PTE corresponding to the virtual memory address. In this manner, memory access time can be reduced because performing this update in the TLB without invalidating the TLB entry can avoid the need for the MMU PT walking circuit to walk the PT again.

In an example, an updated portion of the PT mapping information in a PTE corresponding to a virtual memory address may be stored in a TLB mapping information in a TLB entry corresponding to the virtual memory address in response to the TLB modification instruction being executed by the execution circuit. As an example, system management software, such as an operating system or hypervisor, resets a dirty bit in the PTE when data in the system memory has been written back to a secondary memory. However, the MMU circuit may not detect the dirty bit in the PTE being reset. The system management software in the conventional processor-based system invalidates the TLB entry to force the MMU circuit to walk the PT and recreate the TLB entry. The exemplary processor-based system disclosed herein supports a TLB modification instruction that can cause the dirty bit, for example, to be reset in the TLB entry. Thus, the TLB entry does not need to be invalidated and the MMU PT walking circuit does not need to walk the PT.

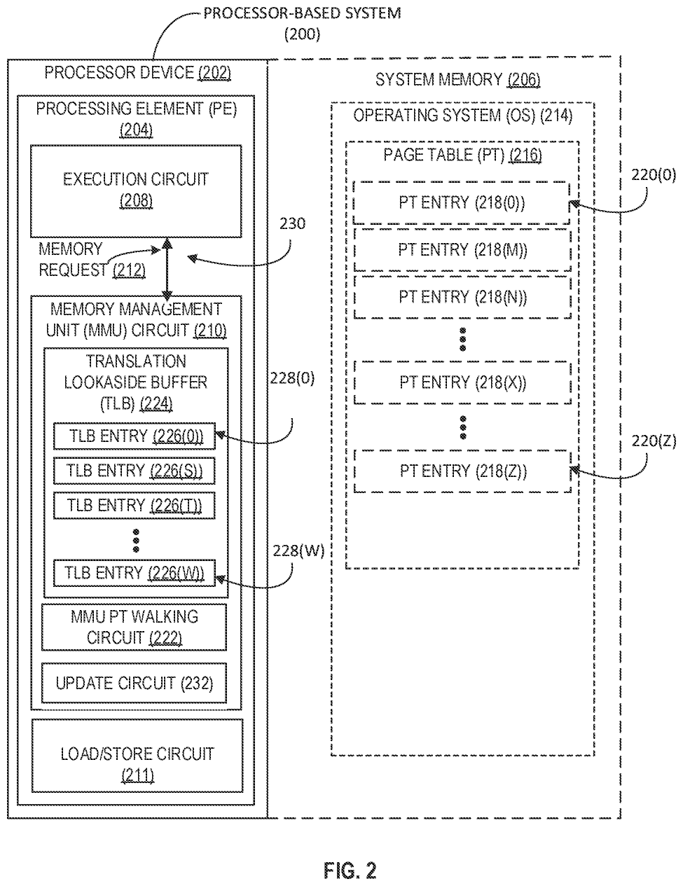

FIG. 2 is a block diagram of an exemplary processor-based system 200 including a processor device 202 with at least one processing element (PE) 204 for processing executable instructions. The processor-based system 200 also includes an optional system memory 206. Before describing a TLB modification instruction for updating a TLB entry of a hardware-managed TLB, details of the processor-based system 200 are first described for context.

With reference to FIG. 2, the system memory 206 may be separate from but closely integrated with the processor-based system 200. The PE 204 includes an execution circuit 208 that is configured to execute a stream of instructions for a process or an operating system, for example. Executed instructions may include memory access instructions for accessing the system memory 206. Memory access instructions include memory read instructions and memory write instructions that access memory locations based on virtual memory addresses. Virtual addressing is used to enable software portability. The PE 204 also includes an MMU circuit 210 that can access memory in response to memory requests 212 from the execution circuit 208. In other words, executing a memory access instruction in the execution circuit 208 causes the execution circuit 208 to generate a memory request 212 to the MMU circuit 210 and the MMU translates the virtual address in the memory access instruction to a physical address. For some memory access instructions, the MMU circuit 210 translates the address and accesses the system memory 206 itself. For other memory access instructions, the MMU circuit 210 provides a translated address to a Load/Store circuit 211, and the Load/Store circuit 211 accesses the system memory 206.

In the processor-based system 200 in FIG. 2, an operating system (OS) 214 controls access to the system memory 206. The OS 214 determines a translation or mapping from a virtual memory address used in a memory access instruction to a physical memory address of a physical memory location in the system memory 206. The OS 214 creates a page table (PT) 216 with PTEs 218(0)-218(Z) in which PT mapping information 220(0)-220(Z) are stored. Each one of the PT mapping information 220(0)-220(Z) includes the information for mapping a virtual memory address in a page in the system memory 206 to a corresponding physical memory address.

In the disclosure below, the label (x) may be used to refer generally to one in a range, such as the range (0) to (Z). For instance, the PTE 218(x) may refer to any one of the PTEs 218(0)-218(Z) and PT mapping information 220(x) may refer to one of the PT mapping information 220(0)-220(Z).

When a memory access instruction for accessing a virtual memory address is executed, the execution circuit 208 generates a memory request 212 to access the system memory 206 including the virtual memory address and sends the memory request 212 to the MMU circuit 210. When the MMU circuit 210 receives the memory request 212, the MMU circuit 210 does not know which of the PTEs 218(x) corresponds to the virtual memory address but needs to access that PTE 218(x) to obtain the corresponding physical memory address. Finding the virtual to physical mapping information required for the memory request 212 includes the MMU circuit 210 “walking” (e.g., searching) through multiple levels of the PT 216 under the control of an MMU PT walking circuit 222. The MMU PT walking circuit 222 may be a circuit within or outside of the MMU circuit 210. In response to finding the PTE 218(x) corresponding to the virtual memory address of the memory request, a PT hit is indicated. Conversely, the PT 216 may not have a PTE 218(x) corresponding to the virtual memory address, in which case a PT miss is indicated.

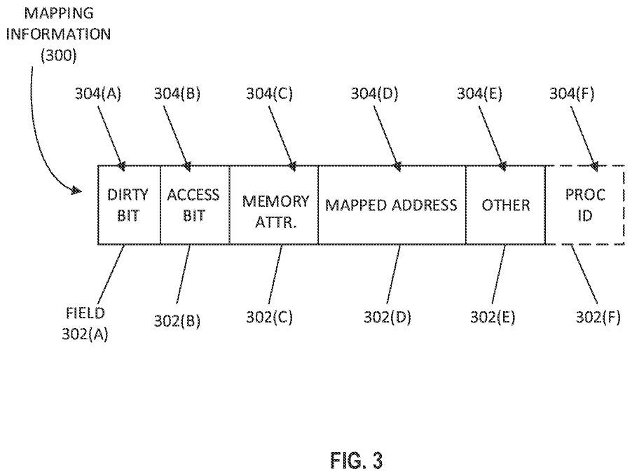

Walking the multiple levels of the PT 216 includes accessing system memory 206 at least once for each level of the PT 216 and the PE 204 is delayed while waiting for each memory access to be completed. If every memory access instruction required the MMU circuit 210 to walk the PT 216, performance of the PE 204 would suffer. In this regard, the MMU circuit 210 includes a translation lookaside buffer (TLB) 224 that includes a plurality of TLB entries 226(0)-226(W). Each of the TLB entries 226(0)-226(W) corresponds to a virtual memory address. The TLB 224 is a cache of the most recently used PTEs 218(0)-218(Z), for example. TLB mapping information 228(0)-228(W) are stored in the TLB entries 226(0)-226(W). The TLB mapping information 228(x) may include some or all of the information in the PT mapping information 220(x). Details of a mapping information 300, which illustrates an example of the TLB mapping information 228(x) and the PT mapping information 220(x), are discussed below with reference to FIG. 3.

Each TLB entry 226(x) corresponds to a virtual memory address and stores the TLB mapping information 228(x). The TLB mapping information 228(x) is based on the PT mapping information 220(x) in a PTE 218(x) corresponding to the virtual memory address. In the present context, a PTE 218(x) or TLB entry 226(x) identified herein as “corresponding to” a virtual memory address or other address indicates that mapping information for such address is stored in the PTE 218(x) or TLB entry 226(x). As an example, the TLB mapping information 228(x) may include some or all of the information contained in the PT mapping information 220(x). The TLB mapping information 228(x) may be created and updated by the MMU circuit 210, which may include copying some or all of the PT mapping information 220(x) to the TLB entry 226(x).

The TLB 224 significantly improves performance of the PE 204 because the TLB 224 allows the MMU circuit 210 to translate a virtual memory address to a physical memory address without the MMU circuit 210 walking the PT 216. However, the TLB mapping information 228(x) can only be used if it remains consistent with the PT mapping information 220(x). As explained further below, the OS 214 may update the PT mapping information 220(x). In conventional processors, the OS does not have access to the TLB, so the OS would invalidate certain TLB entries that may be affected by an update to the PT mapping information. Invalidating the TLB entries 226(x) causes the MMU circuit 210 to walk the PT 216 again to recreate the TLB entries 226(x).

In exemplary aspects described in more detail below, the execution circuit 208 is configured to execute a TLB modification instruction 230 to cause the TLB mapping information 228(x) in a TLB entry 226(x) corresponding to a virtual memory address to be updated. Updating the TLB mapping information 228(x) in this manner (i.e., under software control) reduces the instances in which the TLB entries 226(0)-226(W) are invalidated.

With reference to FIG. 3, the mapping information 300 includes fields 302(A)-302(F), as an example. Field 302(D) includes a mapped address 304(D). The mapped address 304(D) in the processor-based system 200 in FIG. 2 is a physical memory address to which a virtual memory address is mapped. In response to a memory request 212 to that virtual memory address, the MMU circuit 210 reads the mapped address 304(D) from the TLB entry 226(x) corresponding to the virtual memory address and accesses the page of physical memory located at the mapped address 304(D). Field 302(C) stores memory attributes 304(C) of the page of physical memory at the mapped address 304(D). For example, the memory attributes 304(C) in the field 302(C) may include information about read/write/modify permissions for data stored in the page of physical memory at the mapped address 304(D).

Field 302(A) includes a dirty bit 304(A) that indicates whether the page of physical memory located at the mapped address 304(D) is in a modified state. It should be understood that the data stored in a page of the system memory 206 is initially copied into the system memory 206 from a secondary memory (not shown) such as a disk drive, cloud memory, or a non-volatile memory, for example. The dirty bit 304(A) is set to indicate that the data in the page at the mapped address 304(D) has been updated (e.g., written to), which is a condition identified herein as a modified state. The dirty bit 304(A) indicates whether the data in the page is different than the original version of such data stored in the secondary memory. The dirty bit 304(A) may be used to determine whether data in a page in the system memory 206 should be written/copied back to the secondary memory to maintain data integrity.

Field 302(B) stores an access bit 304(B) that indicates a memory address has been accessed (e.g., read or written) by a memory access instruction. The access bit 304(B) may be used by software (e.g., the operating system) in a determination of whether a page should be paged out (i.e., replaced with potentially more pertinent data) when the system memory 206 is being updated with new data (e.g., in a memory swap). An indication that a page has been accessed, by setting the access bit 304(B) is an indication that the data may be needed again and, perhaps, should not be replaced.

Field 302(F) is an optional field that may be used to store a process identifier (ID) 304(F) that identifies a program process associated with the data in the page at the mapped address 304(D). Field 302(E) is used to store other information 304(E) corresponding to the mapped address 304(D). The OS 214 determines the mapped address 304(D) to which a virtual memory address is mapped. The other fields 302(A)-302(C) and 302(E)-302(F) in the PT mapping information 220(x) may also be generated and modified under the control of the OS 214 (“software control”).

With further reference to FIG. 2, when the execution circuit 208 executes a memory access instruction, the MMU circuit 210 receives a memory request 212 including a virtual memory address. Translating the virtual memory address to a physical memory address includes the MMU circuit 210 accessing the mapping information 300. First, the MMU circuit 210 attempts to find a TLB entry 226 corresponding to the virtual memory address. If no such TLB entry 226 exists, the MMU circuit 210 will read the PT mapping information 220(x) from the PT 216. The PTEs 218(0)-218(Z) of the PT 216 are examples of data stored in memory locations in the system memory 206. Thus, the MMU circuit 210 issues a memory read request to access the appropriate PTE 218(x). The MMU circuit 210 creates a TLB entry 226 based on the PT mapping information 220(x).

When the TLB entry 226 corresponding to the virtual memory address is found in the TLB 224, the TLB mapping information 228(x) may indicate that the page including the physical memory address has never been previously accessed. In this case, the MMU circuit 210 will issue a memory write request to access the PTE 218(x) to set the access bit 304(B) in the PT mapping information 220(x), and possibly also to set the dirty bit 304(A). The MMU circuit 210 will also set the access bit 304(B) and/or dirty bit 304(A) in the corresponding TLB entry 226 to have the same information as the PTE 218(x). In such circumstances, PT 216 is being managed by the MMU circuit 210 (e.g., hardware-managed). Once the MMU circuit 210 has updated or obtained the PT mapping information 220(x), the translation information can be forwarded to the Load/Store circuit 211. The Load/Store circuit 211 can issue a memory request to the physical memory address that is the target of the original memory access instruction.

Restating the above, in response to memory access instructions, the MMU circuit 210 updates the PTEs 218(0)-218(Z) as needed and keeps the TLB entries 226(0)-226(W) in the MMU circuit 210 synchronized with the PTEs 218(0)-218(Z). When the MMU circuit 210 first accesses a page of the system memory 206 and the dirty bit 304(A) and/or the access bit 304(B) need to be updated, the MMU circuit 210 is responsible for updating both the PTE 218(x) and the corresponding TLB entry 226(x) to keep them synchronized. The MMU circuit 210 is configured to update the TLB mapping information 228(x) in the TLB entry 226(x) when PT mapping information 220(x) in the PTE 218(x) is changed by the MMU circuit 210. The MMU circuit 210 also creates TLB entries 226 based on a PTE 218(x) when a TLB entry 226 corresponding to a virtual memory address does not exist. Thus, under the management of the MMU circuit 210, the TLB 224 will remain synchronized or consistent with the PT 216. The TLB mapping information 228(x) needs to be consistent with the PT mapping information 220(x) so that operations of the MMU circuit 210 and the OS 214 do not conflict with each other, which could cause a loss of data.

As noted above, address translation is determined by the OS 214. Thus, the OS 214 frequently needs to generate and update the PT mapping information 220(x). In such situations, the OS 214 issues memory access instructions in which the target address is the location of a PTE 218(x). Execution of memory access instructions directed to the PT 216 cause the Load/Store circuit 211 to issue memory access requests to a PTE 218(x). When the PT 216 is the target of memory access instructions from software, such as the OS 214, this is referred to herein as the PT 216 being software-managed or software control. When the PT mapping information 220(x) is updated under software control, the PT 216 and the TLB 224 are no longer synchronized. In a conventional processor, when the OS 214 resets a dirty bit 304(A) in a PTE 218(x), the MMU circuit 210 would be instructed to invalidate the corresponding TLB entry 226. The next time the virtual memory address is accessed and the translation information is needed, the MMU will walk the PT 216 again.

In the context of the processor-based system 200 above, details of a processor supporting a TLB modification instruction 230 for updating a hardware-managed TLB 224 is now presented. As noted, the execution circuit 208 is configured to execute a memory access instruction and generate a memory request 212 to the MMU circuit 210. The memory request 212 is a request to access the system memory 206 based on a first virtual memory address. In addition, the execution circuit 208 is further configured to execute an instruction (e.g., an OS or hypervisor instruction) to cause an update to the PT mapping information 220(x) in the PTE 218(x) corresponding to the first virtual memory address. For example, the OS 214 may reset the dirty bit 304(A) using a memory access instruction. In an exemplary aspect of the processor-based system 200, the execution circuit 208 is further configured to execute the TLB modification instruction 230 to cause the TLB mapping information 228(x) in the TLB entry 226(x) corresponding to the first virtual memory address to be updated based on the PT mapping information 220(x). In other words, the TLB mapping information 228(x) is updated or modified in response to an instruction (e.g., under software control) executed in the execution circuit 208. In one example, the TLB modification instruction 230 causes a portion of the PT mapping information 220(x) in the PTE 218(x) to be stored in the TLB mapping information 228(x) corresponding to the first virtual memory address. Causing the TLB mapping information 228(x) to be updated in response to the TLB modification instruction 230 includes controlling the MMU circuit 210 to perform the update. This update to the TLB mapping information 228(x) differs from an operation of the MMU circuit 210 that is triggered under hardware control (i.e., by update circuit 232) in response to the MMU circuit 210 making an update to the PT mapping information 220(x).

Restating, to further clarify this distinction, the MMU circuit 210 may update the PT mapping information 220(x) corresponding to a virtual memory address under hardware control when a memory page including the virtual memory address is accessed by a memory access instruction. In response to hardware-managed update of the PT mapping information 220(x), the MMU circuit 210 is triggered (e.g., by the update circuit 232) to perform an update of the TLB entry 226(x) that corresponds to the updated PT mapping information 220(x).

In contrast, an instruction, such as an OS instruction may cause the Load/Store circuit 211 to update the PT mapping information 220(x) as the target of a memory access instruction. This is referred to herein as a software-managed update of the PT mapping information 220(x). After the PT mapping information 220(x) in a PTE 218(x) corresponding to a virtual memory address has been updated under software control, the execution circuit can execute a TLB modification instruction 230 to cause the MMU circuit 210 to update the TLB mapping information 228(x) (e.g., under software control).

A benefit of the exemplary aspects disclosed herein will be more easily understood in view of a description of conventional methods. In conventional processor-based systems (not shown) similar to the processor-based system 200, the MMU circuit may be configured to update a TLB mapping information in a TLB entry under control of a TLB update circuit (e.g., hardware), but not in response to a TLB modification instruction 230. In such systems, after the PT mapping information in a PTE is updated (e.g., replaced or modified) in response to a memory access instruction (e.g., an OS instruction), the TLB mapping information in a corresponding TLB entry (i.e., corresponding to the same virtual memory address as the updated PTE) would not be consistent with the updated PT mapping information. Since the prior processor-based system is not configured to execute a TLB modification instruction 230 as described herein, previous processor-based systems would invalidate entire TLB entries. When the MMU circuit attempts to access the invalidated TLB mapping information in an invalidated TLB entry, the MMU circuit is forced to walk the PT again and recreate the TLB mapping information based on the PT mapping information. With the PE 204 being configured to execute the TLB modification instruction 230, the processor-based system 200 reduces the instances in which the TLB entries 226(x) need to be invalidated, which improves processor performance.

As an example, in a conventional processor, the MMU circuit 210 can write data to a first virtual memory address. Under hardware control, the MMU circuit 210 would set the dirty bit 304(A) in the TLB mapping information 228(x) in the TLB entry 226(x) corresponding to the first virtual memory address. The MMU circuit 210 would also set the dirty bit 304(A) in the PT mapping information 220(x) in the PTE 218(x) corresponding to the first virtual memory address. Subsequently, the OS 214 may write the data stored in the memory location mapped to the first virtual memory address back to the secondary memory. The OS instructions executed by the execution circuit 208 can writeback the data and reset the dirty bit 304(A) in the PTE 218(x) corresponding to the first virtual memory address. Because the conventional processor-based system does not execute a TLB modification instruction 230 as disclosed herein, the method used to synchronize the TLB entry 226(x) to this update to the dirty bit 304(A) in the PTE 218(x) is to invalidate the TLB entry 226(x). Then, the MMU circuit in the conventional system is forced to re-walk the PT on the next occurrence of a memory access instruction directed to the first virtual memory address.

In contrast, in the processor-based system 200 in FIG. 2, rather than having to invalidate the entire TLB entry 226(x), the execution circuit 208 is configured to execute a TLB modification instruction 230 that causes the MMU circuit 210 to reset the dirty bit 304(A) in the TLB entry 226(x) corresponding to the first virtual memory address. In this case, the MMU circuit 210 is not forced to re-walk the PT 216. The MMU circuit 210 in conventional MMU circuits may set the dirty bit 304(A) individually but only resets the dirty bit 304(A) in conjunction with updating all fields 302(A)-302(F) of the TLB mapping information 228(x) after it has been invalidated. Thus, one aspect of the exemplary MMU circuit 210 is circuitry configured to update individual fields 302(A)-302(F) of the TLB mapping information 228(x) to be set or reset. It should be noted that the dirty bit 304(A) in the description above is merely one example of TLB mapping information 228(x) that can be updated by the TLB modification instruction 230. It should be further understood that the reference to fields 302(A)-302(F) is only an example. The TLB mapping information 228 and the PT mapping information 220(x) may have different, more, or fewer fields than the fields 302(A)-302(F).

In an example, the TLB modification instruction 230 executed in the execution circuit 208 can cause the MMU circuit 210 to update the access bit 304(B) in the field 302(B) of one of the TLB entries 226(0)-226(W). In other examples, the TLB modification instruction 230 may cause the MMU circuit 210 to update to the memory attributes 304(C), the other information 304(E), and/or the mapped address 304(D).

Updating the TLB mapping information 228(x) in response to the TLB modification instruction 230 may include copying and storing a portion of the PT mapping information 220(x) into the TLB mapping information 228(x). In this context, the portion may include any or all of the contents of any of the fields 302(A)-302(F), such as a state bit in fields 302(A) or 302(B), memory attributes 304(C), the mapped address 304(D), the process ID 304(F) and the other information 304(E). Updating the TLB mapping information 228(x) in response to the TLB modification instruction 230 may include updating the TLB mapping information 228(x) of one or more TLB entries 226(x). For example, the TLB entries 226(x) that are updated by the TLB modification instruction 230 may be determined based on the virtual memory address corresponding to the TLB entry 226(x) matching a target virtual memory address, where a target virtual memory address is one provided in the TLB modification instruction or referenced by the TLB modification instruction. The TLB entries 226(x) that are updated by the TLB modification instruction 230 may be determined based on the TLB mapping information 228(x) stored in the TLB entries 226(x) matching the target virtual memory address. In another example, TLB entries 226(x) in which a particular process ID 304(F) is stored in the TLB mapping information 228(x) may be updated by the TLB modification instruction. Specifically, TLB entries 226(x) in which the process ID 304(F) in the TLB mapping information 228(x) matches a target process ID may be updated. As an example, all TLB entries 226(x) corresponding to a process ID 304(F) may have one of the fields 302(A)-302(F) updated. In another example, the other information 304(E) may contain a VM identifier (ID) and the TLB modification instruction may update all TLB entries 226(x) in which the VM identifier in the TLB mapping information 228(x) matches a target VM identifier. The target virtual memory address, process ID, or VM ID may be included in, associated with or referenced by the TLB modification instruction 230.

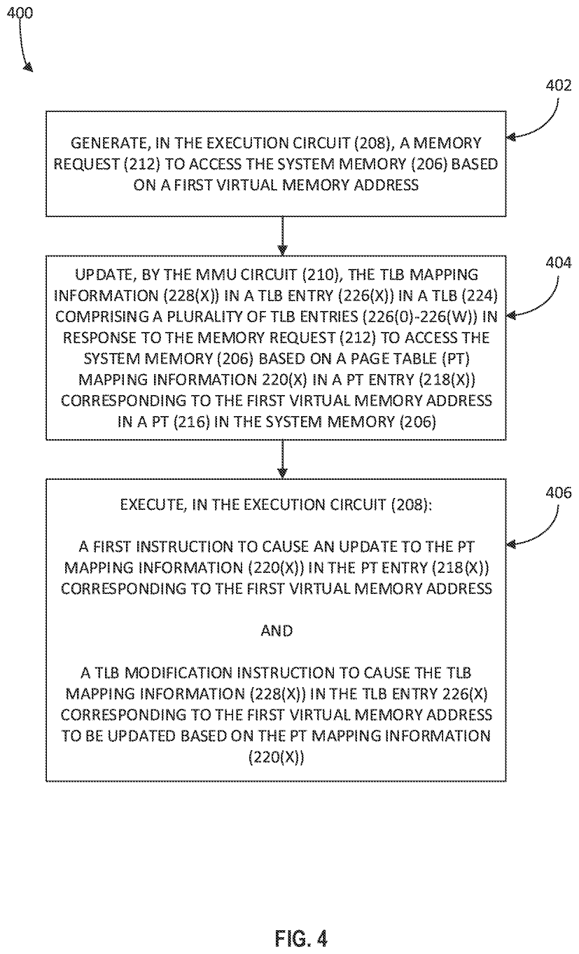

FIG. 4 is a flow chart illustrating a method 400 in the processor-based system 200 of executing a TLB modification instruction 230 to update the TLB entry 226(x) in the TLB 224 without invalidating the TLB entry 226(x). The method 400 includes generating, in the execution circuit 208, a memory request 212 to access the system memory 206 based on a first virtual memory address (block 402). The method 400 includes updating, by the MMU circuit 210, the TLB mapping information 228(x) in a TLB entry 226(x) in a TLB 224 comprising a plurality of TLB entries 226(0)-226(W) in response to the memory request 212 to access the system memory 206 based on a PT mapping information 220(x) in a PTE 218(x) corresponding to the first virtual memory address in a PT 216 in the system memory 206 (block 404). The method further comprises executing, in the execution circuit 208, a first instruction to cause an update to the PT mapping information 220(x) in the PTE 218(x) corresponding to the first virtual memory address and a TLB modification instruction 230 to cause the TLB mapping information 228(x) in the TLB entry 226(x) corresponding to the first virtual memory address to be updated based on the PT mapping information 220(x) (block 406).

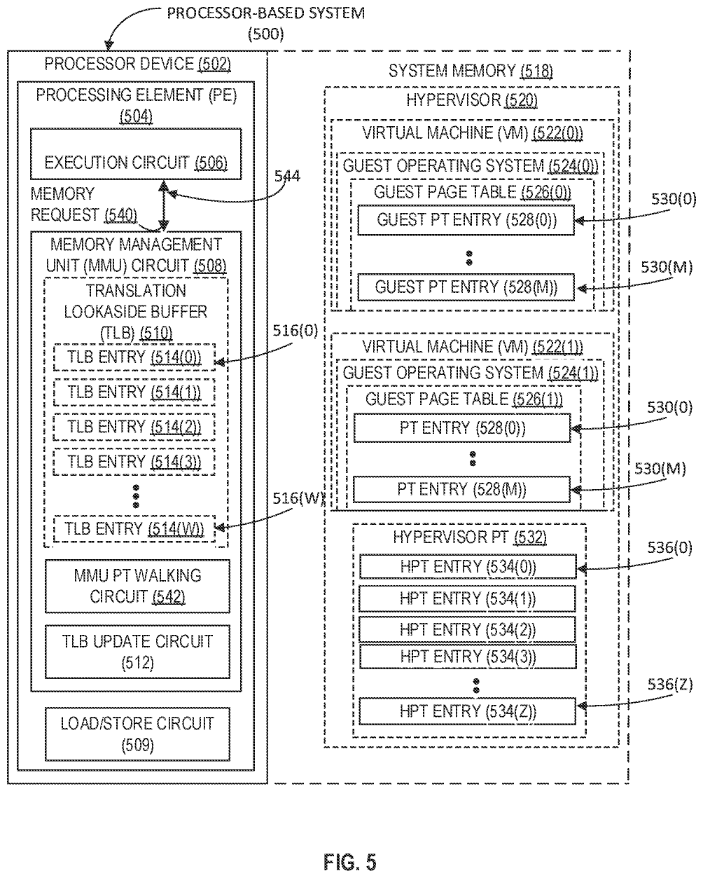

FIG. 5 is a block diagram of another exemplary processor-based system 500 supporting a TLB modification instruction to update a TLB entry in a hardware-managed MMU circuit. The processor-based system 500 includes a processor device 502 with at least one PE 504 for processing executable instructions. The PE 504 includes an execution circuit 506, an MMU circuit 508, and a Load/Store circuit 511. The MMU circuit 508 includes a TLB 510 that can be managed by a TLB update circuit 512 in the MMU circuit 508. The TLB 510 includes a plurality of TLB entries 514(0)-514(W), which may be referred to individually as the TLB entry 514(x) and collectively as the TLB entries 514(0)-514(W). The circuits and hardware of the processor-based system 500 in FIG. 5 may be the processor-based system 200 in FIG. 2. In addition, operation of the PE 504, including the execution circuit 506 and the MMU circuit 508 corresponds to operation of the PE 204 in FIG. 2. For example, the TLB entries 514(0)-514(W) store TLB mapping information 516(0)-516(W) for a virtual memory address. The TLB mapping information 516(x) differs in some aspects from the TLB mapping information 228(x) in FIG. 2, as described below.

The processor-based system 500 includes a system memory 518. In contrast to the OS 214 managing access to the system memory 206 for one or more processes executing on the execution circuit 208, a hypervisor 520 manages access to the system memory 518. The hypervisor 520 manages memory access for a plurality of virtual machines (VMs) 522, including VMs 522(0) and 522(1), for example. Each of the VMs 522 includes a guest OS 524(x) (i.e., guest OSs 524(0) and 524(1), respectively). In particular, VM 522(0) in FIG. 5 includes guest operating system 524(0) and VM 522(1) includes guest operating system 524(1). Each guest OS 524 manages memory access requests for one or more processes executing in the VM 522(x).

Processes issue memory access requests with reference to virtual memory addresses, which allows for portability of a process from one machine or VM to another. Multiple processes executing within the VM 522(0) may access the same virtual memory addresses. Thus, the guest OS 524(0) of the VM 522(0) manages the conflicting memory access requests of multiple processes by mapping the virtual memory addresses of the respective processes to different guest memory addresses based on the view of memory held by the guest OS 524(0). A guest memory address is unique within a VM 522. However, multiple VMs 522(x) share the system memory 518 of the processor-based system 500. Much like the OS 214 avoids conflict between virtual memory addresses used by different processes, the hypervisor 520 avoids conflict between the VMs 522(x) by mapping their respective guest memory addresses to actual physical memory addresses of the system memory 518. Thus, two stages of address mapping are used in the processor-based system 500, a VM stage and a hypervisor stage.

The VM stage of address mapping, from virtual memory address to guest memory address, is implemented by the guest OS 524(0) creating a guest PT 526(0) that includes guest PTEs 528(0)-528(M) for storing guest PT mapping information 530(0)-530(M). The instructions used for purposes of managing address translation by the guest OS 524(x) are referred to herein as VM instructions. The guest PT mapping information 530(0) corresponds to the mapping information 300 in FIG. 3. However, in the guest PT mapping information 530(0), the mapped address 304(D) is a guest memory address to which the guest OS 524(0) maps a virtual memory address used in a process.

The hypervisor stage of address mapping implemented by the hypervisor 520 maps a guest memory addresses to an actual physical memory addresses in the system memory 518. The instructions used for purposes of managing address translation by the hypervisor 520 are referred to herein as hypervisor instructions. The hypervisor 520 creates a hypervisor PT (HPT) 532 including HPT entries (HPTEs) 534(0)-534(Z). The HPTEs 534(0)-534(Z) store HPT mapping information 536(0)-536(Z) which each correspond to a guest physical address of a VM 522. The format of the HPT mapping information 536(0)-536(Z) corresponds to the mapping information 300 in FIG. 3. In the HPT mapping information 536(0)-536(Z), the mapped address 304(D) is an actual physical memory address of a memory location in the system memory 518. The other information 304(E) in the HPT mapping information 536(0)-536(Z) may include a VM identifier (not shown).

An example of operation of the above two stage address mapping structure is provided with reference to a memory access instruction executed by a process in the VM 522(0). The memory access request is directed to a first virtual memory address. The memory access instruction is executed in the execution circuit 506, which generates a memory request 540 to the MMU circuit 508. The MMU circuit 508 checks the TLB 510 to see if one of the TLB entries 514(0)-514(W) corresponds to the first virtual memory address. If there is a TLB miss in the TLB 510, indicating that none of the TLB entries 514(0)-514(W) corresponds to the first virtual memory address, an MMU PT walking circuit 542 walks the guest PT 526(0) looking for a guest PTE 528(x) that corresponds to the first virtual memory address. As previously noted, “corresponds to” in this context indicates the guest PTE 528(x) contains guest PT mapping information 530(x) that maps the first virtual memory address to a guest memory address.

If there is a miss in the guest PT 526(0), a fault occurs and the guest OS 524(0) takes over, eventually creating a guest PTE 528(x) corresponding to the first virtual memory address. If there is a hit in the guest PT 526(0), the MMU PT walking circuit 542 then walks the HPT 532 looking for one of the HPTEs 534(x) corresponding to the guest memory address. If a miss occurs in the HPT 532, a fault occurs and the hypervisor 520 takes over and eventually creates an HPT entry (HPTE) 534(x) corresponding to the guest memory address. If a hit occurs in the HPT 532, the MMU PT walking circuit 542 obtains, from the mapped address 304(D) in the HPT mapping information 536(x), the actual physical address mapped to a first virtual memory address of a process in the VM 522(0). The MMU circuit 508 can complete the memory access request and also generates a TLB mapping information 516(x) in a TLB entry 514(x) corresponding to the first virtual memory address. The TLB mapping information 516(x) directly maps the first virtual memory address to an actual physical memory address. The use of the TLB mapping information 516(x) in the processor-based system 500 is even more valuable toward improving performance perspective than in the processor-based system 200 because of the greater delay involved with walking both the guest PT 526(0) and the HPT 532. Thus, it is important to avoid invalidating the TLB entries 514(0)-514(W).

In response to executing a memory access instruction of a guest OS 524(x), the MMU circuit 508 may update the guest PT mapping information 530(x) or the HPT mapping information 536(x) corresponding to the accessed virtual memory address and update the TLB 510 under the control of the TLB update circuit 512. Similarly, in response to executing a memory access instruction of the hypervisor 520, the MMU circuit 508 may update the HPT mapping information 536(x) corresponding to the accessed virtual memory address and update the TLB 510 under the control of the TLB update circuit 512.

In an exemplary aspect, the execution circuit 506 is configured to execute a TLB modification instruction 544 to cause an update to the TLB mapping information 516(x) in the TLB entry 514(x) corresponding to the first virtual memory address based on updates to the either the guest PT mapping information 530(x) or the HPT mapping information 536(x). The TLB modification instruction 544 may be a VM instruction issued by the guest OS 524(x), or a hypervisor instruction issued by the hypervisor 520. Executing the TLB modification instruction 544 may cause the MMU circuit 508 to update one TLB entry 514(x) or a plurality of the TLB entries 514(0)-514(W). The TLB entries 514(x) to be updated by the TLB modification instruction 544 may be identified by a process identifier (ID), a VM ID, both a process ID and a VM ID, or other information.

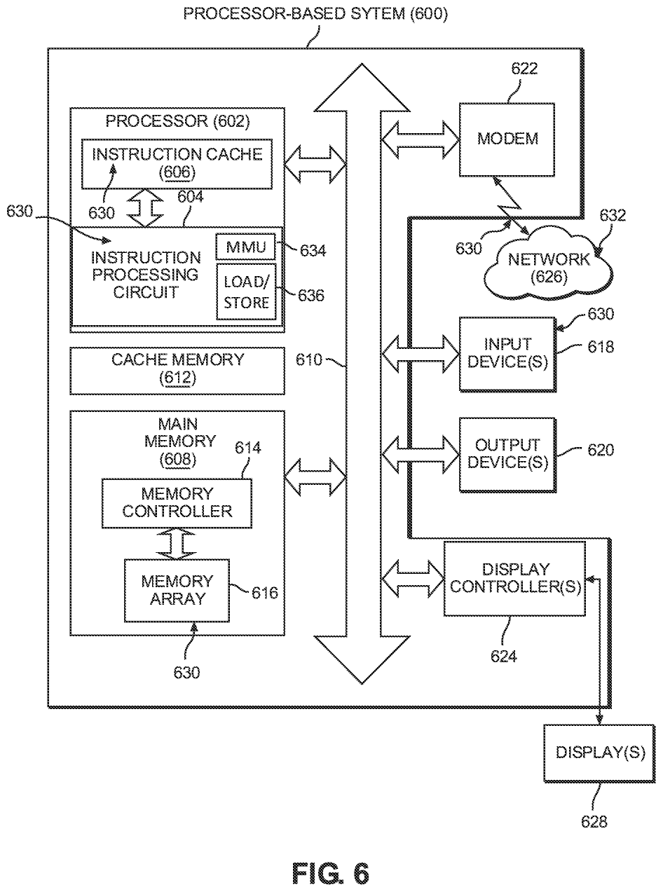

FIG. 6 is a block diagram of an exemplary processor-based system 600 that includes a processor 602 (e.g., a microprocessor) that includes an instruction processing circuit 604. The processor-based system 600 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server, or a user's computer. In this example, the processor-based system 600 includes the processor 602. The processor 602 represents one or more general-purpose processing circuits, such as a microprocessor, central processing unit, or the like. More particularly, the processor 602 may be an EDGE instruction set microprocessor, or other processor implementing an instruction set that supports explicit consumer naming for communicating produced values resulting from execution of producer instructions. The processor 602 is configured to execute processing logic in instructions for performing the operations and steps discussed herein. In this example, the processor 602 includes an instruction cache 606 for temporary, fast access memory storage of instructions accessible by the instruction processing circuit 604. Fetched or prefetched instructions from a memory, such as from a main memory 608 over a system bus 610, are stored in the instruction cache 606. Data may be stored in a cache memory 612 coupled to the system bus 610 for low-latency access by the processor 602. The instruction processing circuit 604 is configured to process instructions fetched into the instruction cache 606 and process the instructions for execution.

The processor 602 and the main memory 608 are coupled to the system bus 610 and can intercouple peripheral devices included in the processor-based system 600. As is well known, the processor 602 communicates with these other devices by exchanging address, control, and data information over the system bus 610. For example, the processor 602 can communicate bus transaction requests to a memory controller 614 in the main memory 608 as an example of a slave device. Although not illustrated in FIG. 6, multiple system buses 610 could be provided, wherein each system bus constitutes a different fabric. In this example, the memory controller 614 is configured to provide memory access requests to a memory array 616 in the main memory 608. The memory array 616 is comprised of an array of storage bit cells for storing data. The main memory 608 may be a read-only memory (ROM), flash memory, dynamic random-access memory (DRAM), such as synchronous DRAM (SDRAM), etc., and a static memory (e.g., flash memory, static random-access memory (SRAM), etc.), as non-limiting examples.

Other devices can be connected to the system bus 610. As illustrated in FIG. 6, these devices can include the main memory 608, one or more input device(s) 618, one or more output device(s) 620, a modem 622, and one or more display controllers 624, as examples. The input device(s) 618 can include any type of input device, including but not limited to input keys, switches, voice processors, etc. The output device(s) 620 can include any type of output device, including but not limited to audio, video, other visual indicators, etc. The modem 622 can be any device configured to allow exchange of data to and from a network 626. The network 626 can be any type of network, including but not limited to a wired or wireless network, a private or public network, a local area network (LAN), a wireless local area network (WLAN), a wide area network (WAN), a BLUETOOTH™ network, and the Internet. The modem 622 can be configured to support any type of communications protocol desired. The processor 602 may also be configured to access the display controller(s) 624 over the system bus 610 to control information sent to one or more displays 628. The display(s) 628 can include any type of display, including but not limited to a cathode ray tube (CRT), a liquid crystal display (LCD), a plasma display, etc.

The processor-based system 600 in FIG. 6 may include a set of instructions 630 to be executed by the processor 602 for any application desired according to the instructions. The instructions 630 may be stored in the main memory 608, processor 602, and/or instruction cache 606 as examples of a non-transitory computer-readable medium 632. The instructions 630 may also reside, completely or at least partially, within the main memory 608 and/or within the processor 602 during their execution. The instructions 630 may further be transmitted or received over the network 626 via the modem 622, such that the network 626 includes computer-readable medium 632.

While the computer-readable medium 632 is shown in an exemplary embodiment to be a single medium, the term “computer-readable medium” should be taken to include a single medium or multiple media (e.g., a centralized or distributed database, and/or associated caches and servers) that stores the one or more sets of instructions. The term “computer-readable medium” shall also be taken to include any medium that is capable of storing, encoding, or carrying a set of instructions for execution by the processor device and that causes the processor device to perform any one or more of the methodologies of the embodiments disclosed herein. The term “computer-readable medium” shall accordingly be taken to include, but not be limited to, solid-state memories, optical medium, and magnetic medium.

The processor 602 in the processor-based system 600 may support a TLB modification instruction for updating a hardware-managed TLB. The processor 602 includes the instruction processing circuit 604 corresponding to the execution circuit 208. The processor 602 includes an MMU 634 and a LOAD/STORE 636 corresponding to the MMU circuit 210 and the Load/Store circuit 211. The processor 602 is configured to execute the TLB modification instruction to cause a TLB entry corresponding to a virtual memory address to be updated based on updates to a page table (PT) entry corresponding to the virtual memory address, as illustrated in FIG. 2.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.); and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processor device, or combinations of both. The components of the distributed antenna systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A processor-based system comprising:
an execution circuit configured to generate a memory request to access a system memory based on a first virtual memory address; and
a memory management unit (MMU) circuit comprising a translation lookaside buffer (TLB) circuit comprising a plurality of TLB entries each corresponding to a virtual memory address, wherein the MMU circuit is configured to update a TLB mapping information in a TLB entry of the plurality of TLB entries corresponding to the first virtual memory address based on a page table (PT) mapping information in a PT entry (PTE) in a PT in the system memory;
wherein the execution circuit is further configured to:
execute a first instruction to cause an update to the PT mapping information in the PTE corresponding to the first virtual memory address; and
execute a TLB modification instruction to cause the TLB mapping information in the TLB entry corresponding to the first virtual memory address to be updated based on the PT mapping information.

2. The processor-based system of claim 1, wherein:
the PT mapping information in the PTE corresponding to the first virtual memory address comprises a hypervisor PT (HPT) mapping information in an HPTE corresponding to the first virtual memory address in an HPT;
the MMU circuit is further configured to:
obtain a guest PT mapping information from a guest PTE corresponding to the first virtual memory address in a guest PT in the system memory; and
update the TLB mapping information in the TLB entry of the plurality of TLB entries corresponding to the first virtual memory address based on the guest PT mapping information; and
the TLB modification instruction comprises a hypervisor instruction.

3. The processor-based system of claim 1, wherein:
the PT mapping information in the PTE corresponding to the first virtual memory address comprises a guest PT mapping information in a guest PTE corresponding to the first virtual memory address in a guest PT in the system memory and the guest PT mapping information comprises a first guest memory address;
the MMU circuit is further configured to:
obtain a hypervisor PT (HPT) mapping information from an HPTE corresponding to the first virtual memory address in an HPT in the system memory; and
update the TLB mapping information in the TLB entry of the plurality of TLB entries corresponding to the first virtual memory address based on the HPT mapping information; and
the TLB modification instruction comprises a virtual machine (VM) instruction.

4. The processor-based system of claim 1, wherein the execution circuit is configured to execute the TLB modification instruction to cause an update to the TLB mapping information by being configured to:
execute the TLB modification instruction to cause a portion of the PT mapping information in the PTE corresponding to the first virtual memory address to be stored in the TLB mapping information in the TLB entry corresponding to the first virtual memory address.

5. The processor-based system of claim 1, wherein the execution circuit is configured to execute the TLB modification instruction to cause an update to the TLB mapping information by being configured to:
execute the TLB modification instruction to cause a state bit of the PT mapping information in the PTE corresponding to the first virtual memory address to be stored in the TLB mapping information in the TLB entry corresponding to the first virtual memory address, wherein the state bit of the PT mapping information indicates a state of data that is accessible based on the first virtual memory address.

6. The processor-based system of claim 5, wherein the state bit comprises a dirty bit used to indicate that the data accessible based on the first virtual memory address is in a modified state.

7. The processor-based system of claim 5, wherein the state bit comprises an access bit used to indicate that the data accessible based on the first virtual memory address has been accessed in response to the execution circuit executing an instruction.

8. The processor-based system of claim 1, wherein the execution circuit is configured to execute the TLB modification instruction to cause an update to the TLB mapping information by being configured to:
execute the TLB modification instruction to cause memory attributes in the PT mapping information in the PTE corresponding the first virtual memory address to be stored in the TLB mapping information in the TLB entry corresponding to the first virtual memory address.

9. The processor-based system of claim 1, wherein the execution circuit is configured to execute the TLB modification instruction to cause the TLB mapping information in the TLB entry corresponding to the first virtual memory address to be updated by being configured to:
execute the TLB modification instruction to cause a first physical memory address in the PT mapping information in the PTE corresponding to the first virtual memory address to be stored in the TLB mapping information in the TLB entry corresponding to the first virtual memory address.

10. The processor-based system of claim 1, wherein the execution circuit is configured to execute the TLB modification instruction to cause the TLB mapping information in the TLB entry corresponding to the first virtual memory address to be updated by being configured to:
execute the TLB modification instruction to cause updates in the TLB mapping information in the TLB entry corresponding to the first virtual memory address without invalidating the TLB entry corresponding to the first virtual memory address.

11. The processor-based system of claim 1, wherein the execution circuit is configured to execute the TLB modification instruction to cause the TLB mapping information in the TLB entry corresponding to the first virtual memory address to be updated by being configured to determine that the first virtual memory address matches a target virtual memory address of the TLB modification instruction.

12. The processor-based system of claim 1, wherein the execution circuit is configured to execute the TLB modification instruction to cause the TLB mapping information in the TLB entry corresponding to the first virtual memory address to be updated by being configured to determine that a process identifier (ID) in the TLB mapping information matches a target process ID of the TLB modification instruction.

13. The processor-based system of claim 1, wherein the execution circuit is configured to execute the TLB modification instruction to cause the TLB mapping information in the TLB entry corresponding to the first virtual memory address to be updated by being configured to determine that a virtual machine (VM) identifier (ID) in the TLB mapping information matches a target VM ID of the TLB modification instruction.

14. A method in a processor-based system, the method comprising:
generating, in an execution circuit, a memory request to access a system memory based on a first virtual memory address;
updating, by a memory management unit (MMU) circuit, a translation lookaside buffer (TLB) mapping information in a TLB entry in a TLB circuit comprising a plurality of TLB entries in response to the memory request, based on a page table (PT) mapping information in a PT entry (PTE) corresponding to the first virtual memory address in a PT in the system memory; and
executing, in the execution circuit:
a first instruction to cause an update to the PT mapping information in the PTE corresponding to the first virtual memory address; and
a TLB modification instruction to cause the TLB mapping information in the TLB entry corresponding to the first virtual memory address to be updated based on the PT mapping information.

15. The method of claim 14, further comprising obtaining, by the MMU circuit, a guest PT mapping information from a guest PTE corresponding to the first virtual memory address in a guest PT in the system memory, wherein:
the PT mapping information in the PTE corresponding to the first virtual memory address comprises a hypervisor page table (HPT) mapping information in an HPTE corresponding to the first virtual memory address in an HPT;
executing the TLB modification instruction further comprises executing a hypervisor instruction; and
causing the TLB mapping information in the TLB entry corresponding to the first virtual memory address to be updated comprises updating the TLB mapping information to be updated based on the guest PT mapping information.

16. The method of claim 14, wherein:
the PT mapping information in the PTE corresponding to the first virtual memory address comprises a guest PT mapping information in a guest PTE corresponding to the first virtual memory address in a guest PT in the system memory and the guest PT mapping information comprises a first guest memory address; and
executing the TLB modification instruction comprises executing a guest operating system (OS) instruction; and
the method further comprises:
obtaining, by the MMU circuit, a hypervisor PT (HPT) mapping information from an HPTE corresponding to the first virtual memory address in an HPT in the system memory; and
updating the TLB mapping information in the TLB entry of the plurality of TLB entries corresponding to the first virtual memory address based on the HPT mapping information.

17. The method of claim 14, further comprising, responsive to executing the TLB modification instruction, causing a portion of the PT mapping information in the PTE corresponding to the first virtual memory address to be stored in the TLB mapping information in the TLB entry corresponding to the first virtual memory address.

18. The method of claim 17, wherein the portion of the PT mapping information comprises a state bit that indicates a state of data accessible based on the first virtual memory address.

19. The method of claim 18, wherein the state bit comprises a dirty bit used to indicate that the data accessible based on the first virtual memory address is in a modified state requiring a writeback to secondary memory.

20. The method of claim 19, wherein the state bit comprises an access bit used to indicate that the data accessible based on the first virtual memory address has been accessed by a memory access instruction.

21. The method of claim 18, wherein the portion of the PT mapping information comprises memory attributes corresponding the first virtual memory address.

22. The method of claim 14, wherein executing the TLB modification instruction to cause the TLB mapping information in the TLB entry corresponding to the first virtual memory address to be updated further comprises causing a first physical memory address in the PT mapping information in the PTE corresponding to the first virtual memory address to be stored in the TLB mapping information in the TLB entry corresponding to the first virtual memory address.

23. The method of claim 14, wherein executing the TLB modification instruction to update the TLB mapping information in the TLB entry corresponding to the first virtual memory address further comprises updating the TLB mapping information without invalidating the TLB entry corresponding to the first virtual memory address.
